(19) United States
(12) Patent Application Publication
(10) Pub. No.: US 2026/0331543 A1
(43) Pub. Date: Oct. 22, 2026

(54) Method for Determining a Percentage of Volume of Hydrogen in a Fuel Cell System, and Fuel Cell System

(71) Applicant: Bayerische Motoren Werke Aktiengesellschaft, Muenchen (DE)

(72) Inventor: Thomas RAUH, Eching (DE)

(21) Appl. No.: 19/113,099

(22) PCT Filed: Sep. 20, 2023
(86) PCT No.: PCT/EP2023/075953

§ 371 Date: Mar. 19, 2025

(30) Foreign Application Priority Data
Sep. 20, 2022 (DE) 10 2022 124 127.0

(51) Int. Cl. H01M 8/0444; H01M 8/0438; H01M 8/04537

(52) U.S. Cl. CPC H01M 8/04447; H01M 8/04388; H01M 8/04402; H01M 8/04432; H01M 8/04582

(57) ABSTRACT

A method for determining a percentage of volume of hydrogen in a fuel cell system, and a fuel cell system are described. No hydrogen sensor is used in the fuel cell system. The percentage of volume of hydrogen in an anode gas is determined on the basis of a pressure difference between the anode inlet and anode outlet of the fuel cell and taking into account current drawn from the fuel cell system.

### BACKGROUND AND SUMMARY

The present invention relates to a method for determining a percentage of volume (vol. %) of hydrogen in a fuel cell system and to a fuel cell system.

Fuel cell systems are high-energy power providers, which produce energy by the reaction of hydrogen with oxygen. The oxygen is provided in this case in the form of air which contains oxygen. To improve the efficiency of the fuel cell system, it is necessary to know the hydrogen content, and in particular the hydrogen concentration on the anode side of a fuel cell system. The hydrogen concentration is ascertained nowadays in a complex and costly manner by way of high-sensitivity hydrogen sensors.

Moving beyond the current technology, it is an object of the present disclosure to specify a simplified and cost-effective method for determining a percentage of volume of hydrogen on an anode side of a fuel cell system. In addition, it is an object of the present disclosure to specify a fuel cell system by way of which it is made possible to determine a percentage of volume of hydrogen on an anode side of the fuel cell system in order to be able to increase the efficiency of the fuel cell system.

The objects may be achieved by the independent claims. The dependent claims have advantageous refinements and embodiments of the invention as the content.

Accordingly, the object is achieved by a method for determining a percentage of volume of hydrogen which is present with respect to a gas mixture on an anode side of a fuel cell system. The method comprises the following steps.

Initially, a fuel cell system is provided. The fuel cell system comprises at least one fuel cell and in particular a plurality of fuel cells, which are connected in series in the form of a cell stack. Each fuel cell comprises an anode having an anode inlet and an anode outlet, a cathode, and a membrane lying between the anode and the cathode. If only one fuel cell is present in the fuel cell system, the anode side corresponds to the side of one anode present in this fuel cell. If two or more fuel cells are present, the anode side of the fuel cell system means the entirety of all anodes of all fuel cells connected in series and therefore connected to one another in a gas circuit.

The fuel cell system is operated. This means that the fuel cell system is not in a startup process, but rather in continuous operation of energy generation.

During the operation of the fuel cell system, the pressure is measured using a pressure sensor at the anode inlet, and in particular upstream of the anode inlet, which in the case of multiple fuel cells connected in series, corresponds to the area which is located on the anode side in front of the first fuel cell, in other words, upstream of the first anode. The pressure substantially corresponds to the gas mixture pressure at the anode inlet, thus in other words to the anode gas pressure. In a negligibly small proportion, the gas mixture can contain water vapor. This has no significant influence on the measurement result, however, since it applies to the same extent both for the fuel cell system and for a reference system which is still to be described and therefore the influence is already contained in the reference characteristic curves.

Also during the operation of the fuel cell system, the pressure is measured by way of a further pressure sensor at the anode outlet, thus in particular downstream of the anode outlet, which in the case of multiple fuel cells connected in series corresponds to an area which is located on the anode side after the last fuel cell, in other words downstream of the last anode. The pressure substantially corresponds to the pressure of the gas mixture on the anode side of the fuel cell system. In addition to hydrogen, the gas mixture can also contain nitrogen and water vapor, which are also detected by the measurement. Since water vapor is only contained in very small proportions in the gas mixture of the anodes, it can again be neglected.

A pressure difference (Δp) can be determined from the measured pressure at the anode inlet (p_{anode inlet}) and the measured pressure at the anode outlet (p_{anode outlet}). The pressure difference (Δp) is composed as follows:

Δp=p_{anode inlet}−p_{anode outlet}=p_{current draw}+p_{volume flow}

The pressure is specified here in kPa.

In this case, p_{current draw} corresponds to the hydrogen pressure which relates to the current draw from the fuel cell system and p_{volume flow} is the pressure which is generated by friction losses as a gas mixture flows through the fuel cell stack on the anode side of the fuel cell system.

To determine p_{current draw}, in an additional method step the current drawn from the fuel cell system is measured by using a sensor. The current is measured here in amps. p_{current draw} can be ascertained according to the following formulas 1 and 2:

p_{current draw}=n_{H2_current draw}*R*T/V formula 1

In formula 1:
n_{H2_current draw}=material quantity [mol] of H₂ which relates to the current draw
R=general gas constant: 8.3145 [J/(mol*K)]
T=fuel cell temperature [K] (in the case of two or more fuel cells, T corresponds to the average temperature of the fuel cell stack; in any case, T represents the temperature of the anode gas mixture measured by using a temperature sensor)
V=volume of the anode [m³] in the volume flow direction between the two pressure measuring areas (generally between two pressure sensors, thus a pressure sensor at the anode inlet and a pressure sensor at the anode outlet) (in the case of two or more fuel cells in the fuel cell system, V corresponds to the total volume of all anodes)

n_{H2_current draw}=I*t*n_{cells}/F/2 formula 2

In formula 2:
I=current drawn from the fuel cell system [amps]
t=time [s] (active time of the current drawn)
n_{cells}=number of the cells in the fuel cell system which are connected in series
F=96485.3 [C/mol] (Faraday constant).

The number 2 stands for the number of electrons per hydrogen molecule H₂.

For further determination of the percentage of volume of hydrogen, it is necessary to provide reference values. The reference values are essentially obtained like the values of the above-described fuel cell system. To ascertain the reference values, a reference fuel cell system is provided, which is advantageously constructed precisely like the existing fuel cell system and which comprises at least one reference fuel cell having a reference anode having a reference anode inlet and a reference anode outlet, having a reference cathode and a reference membrane lying between the reference anode and the reference cathode. If the fuel cell system comprises multiple fuel cells, the reference fuel cell system advantageously also comprises multiple fuel cells.

The reference values required for the method are obtained from the reference fuel cell system as follows. The same principles and assumptions can be made in this case as for the fuel cell system and the same definitions as disclosed above apply in the transferred sense:

Initially, a reference pressure is measured at the reference anode inlet by using a pressure sensor. As already shown for the fuel cell system disclosed above, “reference electrode inlet” means upstream of the reference anode and, in the case of multiple reference fuel cells connected in series, upstream of the first reference anode of the reference fuel cell stack.

A reference pressure is then measured at the reference anode outlet. “Reference electrode outlet” in this case again means downstream of the reference anode and, in the case of multiple reference fuel cells connected in series, downstream of the last reference anode of the reference fuel cell stack.

During the pressure measurements of the reference pressures, a gas flow in the reference fuel cell system is changed from 100 percentage of volume nitrogen by adding hydrogen to 100 percentage of volume hydrogen and the respective percentage of volume of hydrogen can be ascertained. This can be carried out, for example, by way of gas chromatography in that a partial volume flow to be measured is fed to a gas chromatograph. To reduce the error, the concentration of hydrogen and additionally also the concentration of nitrogen are preferably ascertained twice as close as possible in each case to the position at which the pressure at the anode inlet and the pressure at the anode outlet are also measured. All calculations relate to the mean anode gas concentration which is ascertained from the mean value of the two concentration sensor values and stands for the average hydrogen concentration in the fuel cell stack. Furthermore, in each case the current drawn from the reference fuel cell system is measured in amps by using a current sensor. Moreover, the water concentration in the gas mixture can also be ascertained to further reduce the error.

A reference pressure difference Δp_{ref} is determined from the ascertained pressures, wherein the following applies:

Δp_{ref}=p_{ref_current draw}+p_{ref_volume flow}

In this case, p_{ref_current draw} corresponds to the hydrogen pressure which relates to the current draw from the reference fuel cell system and p_{ref_volume flow} is the pressure which is generated by friction losses as a gas mixture flows through the reference fuel cell stack on the anode side of the reference fuel cell system. The level of the friction losses is significantly dependent here, due to the large density difference between the gases nitrogen and hydrogen, on the existing hydrogen volume proportion in the gas mixture on the anode side of the reference fuel cell system.

The current drawn and measured from the reference fuel cell system is required to determine p_{current draw}.

p_{ref_current draw} can be ascertained according to the following formulas 3 and 4:

p_{ref_current draw}=n_{ref_H2_current draw}*R*T_{ref}/V_{ref} formula 3

In formula 3:
n_{ref_H2_current draw}=material quantity [mol] of H₂ which relates to the current draw
R=general gas constant: 8.3145 [J/(mol*K)]
T_{ref}=reference fuel cell temperature [K] (in the case of two or more reference fuel cells, T_{ref} corresponds to the average temperature of the reference fuel cell stack; in any case, T_{ref} represents the temperature of the reference anode gas mixture measured by using a temperature sensor) and
V_{ref}=volume of the reference anode [m³] in the volume flow direction between the two pressure measuring areas (generally between two pressure sensors, thus a pressure sensor at the anode inlet and a pressure sensor at the anode outlet) (in the case of two or more reference fuel cells in the reference fuel cell system, V corresponds to the total volume of all reference anodes).

n_{ref_H2_current draw}=I_{ref}*t*n_{ref_cells}/F/2 formula 4

In formula 4:
I_{ref}=current drawn from the reference fuel cell system [amps]
t=time [s] (active time of the current drawn)
n_{ref_cells}=number of the cells in the reference fuel cell system which are connected in series
F=96485.3 [C/mol] (Faraday constant)

The number 2 stands for the number of electrons per hydrogen molecule H₂.

p_{ref_volume flow} is known from the respective gas mixture nitrogen/hydrogen which is fed to the reference fuel cell system on the anode side, since hydrogen and nitrogen are mixed in a predetermined ratio here and the reference pressure difference is determined following therefrom.

In a further method step, the pressure difference (Δp) ascertained for the fuel cell system is compared with reference pressure differences (Δp_{ref}) ascertained for the reference fuel cell system and therefore the volume proportion of nitrogen to hydrogen is obtained in each case in percentage of volume, which corresponds to the ascertained pressure difference (Δp).

Since the ratio in percentage of volume of hydrogen to nitrogen is known for the respective reference pressure difference (Δp_{ref}), the percentage of volume of hydrogen can be ascertained from the pressure difference (Δp) for the same reference pressure difference (Δp_{ref}).

The reference data can be ascertained for the same fuel cell system as is used in the method and for which the percentage of volume of hydrogen is to be ascertained on the anode side. The method is implementable easily and cost-effectively, because it only requires for one thing providing a reference fuel cell system to ascertain the reference data and then only pressure sensors in the fuel cell system. The temperature and the current are output as a standard feature in any case. The method is therefore also cost-effective because costly and sensitive hydrogen sensors can be dispensed with.

The fuel cell system can advantageously be operated in static operation or in dynamic operation. Dynamic operation is understood here as such an operation in which the current changes either by more than 10% (minimum change 2 A) (in very small fuel cell stack currents <20 A) or changes by more than 15 A (at higher fuel cell stack currents (>150 A), the limit can be, for example, less than 10%), in comparison with an ascertained mean value of the current from the last 100 ms of measurement time. Dynamic operation supplies less accurate values for the percentage of volume of hydrogen than static operation.

It is therefore particularly preferred if the pressure measurements are first activated again when the above-mentioned condition of more than 10% (or <15 A) does not apply continuously for dynamic operation for 1 s. The system has then reached a stationary state.

Since the respective pressure differences are easier to determine for a static system and therefore the determination of the volume proportion of hydrogen in the gas mixture on the anode side of the fuel cell system can be ascertained significantly more accurately, static operation of the fuel cell system is preferred over dynamic operation.

The anode exhaust gas emerging from the anode outlet is preferably recirculated from the anode outlet to the anode inlet and is therefore also called recirculation gas. This enables not only recycling of the anode exhaust gas, but also contributes to the stationary operation of the fuel cell system and therefore facilitates more accurate determination of the percentage of volume of hydrogen on the anode side.

To further reduce possible errors in the determination of the percentage of volume of hydrogen on the anode side, it is advantageously provided that the water is separated from the anode exhaust gas. The water is particularly advantageously separated here before the measurement of the pressure at the anode outlet.

Further advantageously, the anode exhaust gas is recirculated actively, in particular by using a motor, or passively. Passive recirculation is executed here by feeding hydrogen from a storage container, such as a tank, to the fuel cell system. Active recirculation is preferred here since it generates a particularly constant volume flow through the anode side of the fuel cell system.

To further improve the method, and in particular to increase the accuracy of the percentage of volume for the value of the hydrogen, preferably only those reference pressures are taken into consideration to ascertain the reference data for which a reference pressure difference over a measurement duration of at least 100 ms is substantially constant.

Furthermore, a fuel cell system is also described according to the technology. The fuel cell system is in particular configured to carry out the method described according to the technology above. Therefore, all definitions and explanations above on the method according to the technology are also applicable to the fuel cell system according to the technology. The respective advantageous refinements are also mutually applied.

For this purpose, the fuel cell system comprises at least one fuel cell having an anode having an anode inlet and an anode outlet, a cathode, and a membrane lying between the anode and the cathode. Two or more fuel cells in a fuel cell stack can also be provided connected in series.

The fuel cell system comprises a first pressure sensor at the anode inlet for measuring the pressure at the anode inlet (in the case of two or more fuel cells, the pressure is measured before the inlet into the first anode connected in series) and a second pressure sensor at the anode outlet for measuring the pressure at the anode outlet (in the case of two or more fuel cells, the pressure is measured after the outlet out of the last anode connected in series).

Furthermore, the fuel cell system comprises a temperature sensor for determining the temperature in Kelvin in the fuel cell or in the fuel cell stack, which corresponds to the temperature of the gas mixture on the anode side of the fuel cell system.

Furthermore, the fuel cell system comprises a sensor for determining the current drawn from the fuel cell system (measured in amps) and a storage device. The storage device comprises:

Reference values, which were obtained for a reference fuel cell system that comprises at least one reference fuel cell having a reference anode having a reference anode inlet and a reference anode outlet, a reference cathode, and a reference membrane lying between the reference anode and the reference cathode, wherein the reference values were obtained as follows:
by measuring a reference pressure at the reference anode inlet, by measuring a reference pressure at the reference anode outlet, wherein during the measurement of the reference pressures, a gas flow in the reference fuel cell system was changed from 100 percentage of volume nitrogen by adding hydrogen to 100 percentage of volume hydrogen, reference values, which represent the current respectively drawn from the reference fuel cell system, and
reference pressure differences Δp_{ref}, wherein

Δp_{ref}=p_{ref_current draw}+p_{ref_volume flow}
wherein p_{ref_current draw} was ascertained according to the following formulas 3 and 4 from the measured value for the current drawn from the reference fuel cell system:

p_{ref_current draw}=n_{ref_H2_current draw}*R*T_{ref}/V_{ref} formula 3
with
n_{ref_H2_current draw}=material quantity [mol] of H₂ which relates to the current draw
R=general gas constant: 8.3145 [J/(mol*K)]
T_{ref}=reference fuel cell temperature [K] (in the case of two or more reference fuel cells, T_{ref} corresponds to the average temperature of the reference fuel cell stack; in any case, T_{ref} represents the temperature of the anode gas mixture measured by using a temperature sensor), and
V_{ref}=volume of the reference anode [m³] in the volume flow direction between the two pressure measuring areas (generally between two pressure sensors, thus a pressure sensor at the anode inlet and a pressure sensor at the anode outlet) (in the case of two or more fuel cells in the fuel cell system, V corresponds to the total volume of all anodes).

n_{ref_H2_current draw}=I_{ref}*t*n_{ref_cells}/F/2 formula 4
I_{ref}=current drawn from the reference fuel cell system [amps]
t=time [s] (the active time of the current drawn)
n_{ref_cells}=number of the cells in the reference fuel cell system which are connected in series
F=96485.3 [C/mol] (Faraday constant)

The number 2 stands for the number of electrons per hydrogen molecule.

p_{ref_volume flow} was determined from the respective gas mixture nitrogen/hydrogen.

The fuel cell system furthermore comprises a monitoring device, which is configured to determine a pressure difference (Δp) between the pressure at the anode inlet and the pressure at the anode outlet) pressure difference between the first pressure sensor and the second pressure sensor), wherein the pressure difference (Δp) has the following composition:

Δp=p_{current draw}+p_{volume flow}

The monitoring device is furthermore configured to compare the ascertained pressure difference (Δp) with the reference pressure difference (Δp_{ref}) to ascertain the volume proportion in percentage of volume of nitrogen to hydrogen, which corresponds to the ascertained pressure difference (Δp) and to ascertain a percentage of volume of hydrogen in the anode gas mixture from the volume proportions of nitrogen to hydrogen which were obtained for the reference fuel cell system at a determined reference pressure difference (Δp_{ref}), wherein the percentage of volume of hydrogen was measured for the reference fuel cell system and is therefore known.

Further advantageously, the fuel cell system comprises an output device for outputting the ascertained hydrogen proportion, which can be designed, for example, in the form of a monitor or display.

The fuel cell system according to the disclosure is designed like a conventional fuel cell system and has two pressure sensors for determining a pressure difference between the anode inlet and the anode outlet. The fuel cell system is therefore very efficient and cost-effective and reliably enables the determination of a percentage of volume of hydrogen on the anode side of the fuel cell system. The efficiency of the fuel cell system can thus also be increased.

Further advantageously, the fuel cell system comprises a recirculation circuit for recirculating the anode exhaust gas emerging from the anode outlet from the anode outlet to the anode inlet. This enables more efficient utilization of the combustion gas and contributes to distributing the gas mixture more evenly from and to the anode, which reduces errors in the determination of the percentage of volume of hydrogen on the anode side of the fuel cell system.

Further advantageously, the fuel cell system comprises a water separator in the recirculation circuit in view of reducing measurement errors with respect to the determination of the percentage of volume of hydrogen, wherein the water separator is in particular arranged upstream of the second pressure sensor.

To improve the static operation of the fuel cell system, it is further advantageously provided that the recirculation circuit comprises a motor for active recirculation of the anode exhaust gas.

### BRIEF DESCRIPTION OF THE DRAWINGS

Further details, features, and advantages of the technology result from the following description and the figures. In the figures:

FIG. 1 shows a fuel cell system according to a first advantageous refinement and

FIG. 2 shows an exemplary diagram for the determination of the percentage of volume of hydrogen in a fuel cell system according to a second advantageous refinement.

Only the essential aspects of the present technology are shown in the figures. All other aspects have been omitted for the sake of clarity.

### DETAILED DESCRIPTION OF THE DRAWINGS

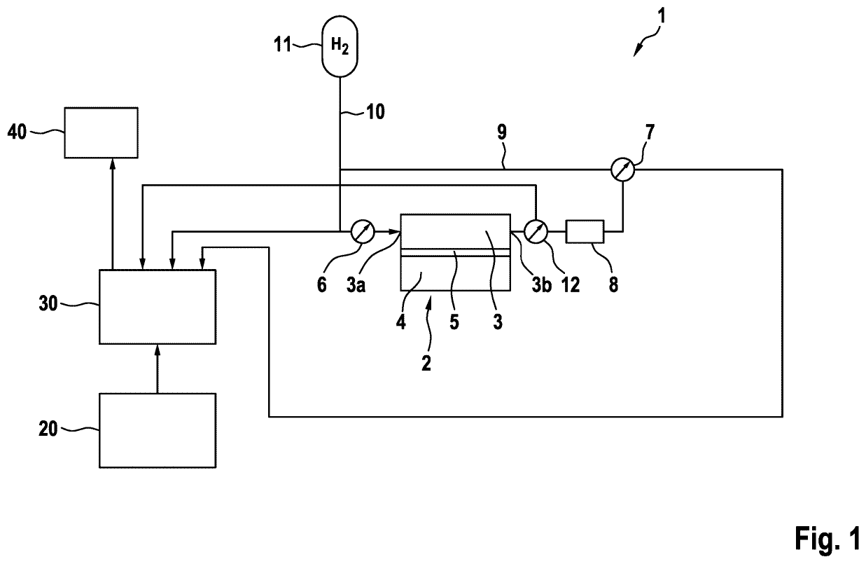

FIG. 1 shows, in simplified and schematic form, a fuel cell system 1 according to a first advantageous refinement. The fuel cell system 1 comprises a fuel cell stack. A single fuel cell 2 is shown as an example of the fuel cell stack. Multiple fuel cells 2 are connected in series in the fuel cell stack. Each fuel cell 2 comprises an anode 3 having an anode inlet 3a and an anode outlet 3b, a cathode 4, and a membrane 5 lying between the anode 3 and the cathode 4.

A first pressure sensor 6, which is configured for measuring the pressure at the anode inlet 3a, is arranged at the anode inlet 3a, and thus is somewhat upstream of the anode inlet 3a. A second pressure sensor 7 for measuring the pressure at the anode outlet 3b is arranged at the anode outlet 3b, and thus is somewhat downstream of the anode outlet 3b. A water separator 8 is integrated into the anode exhaust gas line upstream of the second pressure sensor 7.

The anode exhaust gas which emerges from the anode outlet 3b is recirculated via a recirculation circuit 9 to the anode inlet 3a. Moreover, hydrogen can be fed into the recirculation circuit 9 via a hydrogen supply line 10, for example from a tank 11, and supplied to the anode inlet 3a.

Furthermore, a temperature sensor 12 is attached upstream, thus directly at the anode outlet 3b, for determining the temperature in the fuel cell 2 and therefore on the anode side of the fuel cell in the anode exhaust gas. Alternatively, a temperature sensor can also be arranged in a cooling circuit of the fuel cell system 1.

The fuel cell system 1 moreover contains a sensor (not shown) for determining the current drawn from the fuel cell system 1 and a storage device 20. The storage device 20 contains reference values, obtained for a reference fuel cell system having a reference fuel cell stack, which comprises a number of reference fuel cells that corresponds to the number of fuel cells in the fuel cell stack, each having a reference anode having a reference anode inlet and a reference anode outlet, a reference cathode, and a reference membrane lying between the reference anode and the reference cathode, wherein the reference values were obtained as follows:

On the one hand, by measuring a reference pressure at the reference anode inlet, by measuring a reference pressure at the reference anode outlet, wherein during the measurement of the reference pressures, a gas flow in the reference fuel cell system was changed from 100 percentage of volume nitrogen by adding hydrogen to 100 percentage of volume hydrogen. On the other hand, reference values are stored which represent the current respectively drawn from the reference fuel cell system and reference pressure differences Δp_{ref}, with Δp_{ref}=p_{ref_current draw}+p_{ref_volume flow}, wherein p_{ref_current draw} was ascertained according to the following formulas 3 and 4 from the measured value for the current drawn from the reference fuel cell system:

p_{ref_current draw}=n_{ref_H2_current draw}*R*T_{ref}/V_{ref} formula 3
with
n_{ref}_H2_current draw=material quantity [mol] of H₂ which relates to the current draw
R=general gas constant: 8.3145 [J/(mol*K)]
T_{ref}=reference fuel cell temperature [K] and
V_{ref}=volume of the reference anode [m3] and

n_{ref_H2_current draw}=I_{ref}*t*n_{ref_cells}/F/2 formula 4
with
I_{ref}=current drawn from the reference fuel cell system [amps]
t=time [s] (the active time of the current drawn)
n_{ref_cells}=number of the cells in the reference fuel cell system which are connected in series
F=96485.3 [C/mol]
The number 2 corresponds to the number of the electrons per H₂ molecule and wherein p_{ref_volume flow} was determined from the respective gas mixture nitrogen/hydrogen.

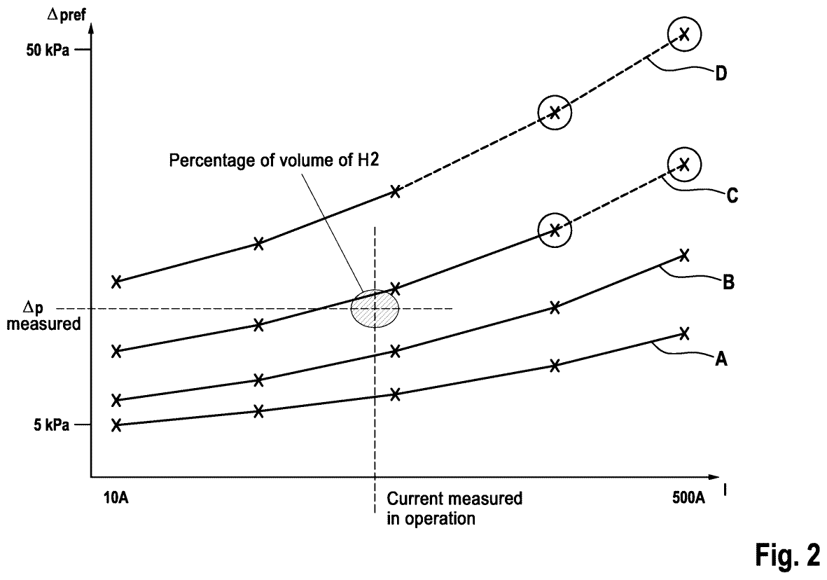

Reference is made to FIG. 2 with respect to the reference data. FIG. 2 shows four curves A, B, C, and D. Δp_{ref} are plotted over the current drawn in the reference fuel cell system in amps.
Curve A was obtained for a reference gas mixture which contained 80 percentage of volume nitrogen and 20 percentage of volume hydrogen.
Curve B was obtained for a reference gas mixture which contained 50 percentage of volume nitrogen and 50 percentage of volume hydrogen.
Curve C was obtained for a reference gas mixture which contained 20 percentage of volume nitrogen and 80 percentage of volume hydrogen.
Curve D was obtained for a reference gas mixture which contained 100 percentage of volume hydrogen.

“X” is represented by measurement points in each case. The circle measurement points are estimated values.

The fuel cell system 1 furthermore comprises a monitoring device 30, which is configured to determine a pressure difference (Δp) between the pressure at the anode inlet 3a and the pressure at the anode outlet 3b of the fuel cell system 1, wherein the pressure difference (Δp) has the following composition:

Δp=p_{current draw}+p_{volume flow}

p_{current draw} can be ascertained according to following formulas 1 and 2:

p_{current draw}=n_{H2_current draw}*R*T/V formula 1
with
n_{H2_current draw}=material quantity [mol] of H₂ which relates to the current draw
R=general gas constant: 8.3145 [J/(mol*K)]
T=fuel cell temperature [K] and
V=volume of the anode [m³] and

n_{ref_H2_current draw}=I*t*n_{cells}/F/2 formula 2
with
I=current drawn from the fuel cell system (1) [amps]
t=time [s] (active time of the current drawn)
n_{cells}=number of the cells (2) in the fuel cell system (1) which are connected in series
F=96485.3 [C/mol].

The number 2 corresponds to the number of the electrons per H₂ molecule.

The monitoring device 30 is furthermore configured to compare the ascertained pressure difference (Δp) with the reference pressure differences (Δp_{ref}) from the storage 20 to ascertain the volume proportion in percentage of volume of nitrogen to hydrogen, which corresponds to the ascertained pressure difference (Δp). This step is shown in FIG. 2 by the horizontal dashed line Δp. The pressure difference Δp ascertained by the monitoring device 30 for the fuel cell system 1 is compared with the reference pressure differences Δp_{ref}. Where the two values meet on the Y axis, Δp=Δp_{ref}.

Since the current I drawn from the fuel cell system 1 is also measured and values are supplied to the monitoring device 30, the monitoring device is furthermore configured to ascertain the percentage of volume of hydrogen in the anode exhaust gas from the volume proportions of nitrogen to hydrogen in the reference system and to output this value in an output device 40.

This step is also illustrated in FIG. 2, namely on the X axis, which shows the current drawn from the reference fuel cell system. Since the current drawn from the fuel cell system 1 is measured, it is approximately at 200 A in FIG. 2, at the intersection of the horizontal curve of Δp and the vertical curve of the measured current drawn, the nitrogen-hydrogen concentration ratio can be read or ascertained in each case in percentage of volume. Since the accurate gas mixture composition nitrogen to hydrogen is known for the respective reference curves A to D on the basis of gas chromatography measurements to ascertain the hydrogen content in percentage of volume in the reference gas mixture, the hydrogen concentration, thus the percentage of volume of hydrogen in the anode 3 of the fuel cell system 1 can also be derived from the intersection of the mentioned lines.

Both the fuel cell system 1 and the method for determining the percentage of volume of hydrogen on the anode side of the fuel cell system 1 are designed simply. The fuel cell system 1 corresponds to a conventional fuel cell system, expanded by a storage device and a monitoring device as well as a first pressure sensor 6 and a second pressure sensor 7. The method is applicable easily and cost-effectively without the use of hydrogen sensors.

### LIST OF REFERENCE SIGNS

1 fuel cell system
2 fuel cell
3 anode
3a anode inlet
3b anode outlet
4 cathode
5 membrane
6 first pressure sensor
7 second pressure sensor
8 water separator
9 recirculation circuit
10 hydrogen supply line
11 hydrogen tank
12 temperature sensor
20 storage device
30 monitoring device
40 output device

1-10. (canceled)

11. A method for determining a percentage of volume (vol. %) of hydrogen on an anode side of a fuel cell system, the method comprising:
operating a fuel cell system comprising at least one fuel cell having an anode, a cathode, and a membrane disposed between the anode and the cathode, the anode having an anode inlet and an anode outlet;
measuring the pressure at the anode inlet;
measuring the pressure at the anode outlet;
determining a pressure difference (Δp) between the pressure at the anode inlet and the pressure at the anode outlet;
determining current (I) drawn from the fuel cell system;
obtaining reference values for a reference fuel cell system comprising at least one reference fuel cell having a reference anode, a reference cathode, and a reference membrane disposed between the reference anode and the reference cathode, the reference anode having a reference anode inlet and a reference anode outlet;
comparing the pressure difference (Δp) with reference pressure difference (Δp_{ref}) to ascertain a volume proportion of nitrogen to hydrogen in each case in percentage of volume; and
ascertaining a percentage of volume of hydrogen from the volume proportions of nitrogen and hydrogen.

12. The method according to claim 11, wherein the pressure difference (Δp) determined from the pressure at the anode inlet and the pressure at the anode outlet is composed as follows: (Δp)=p_{current draw}+p_{volume flow}, and further comprising:
ascertaining p_{current draw} according to following formulas 1 and 2:
p_{current draw}=n_{H2_current draw}*R*T/V formula 1
wherein n_{H2_current draw}=material quantity [mol] of H₂ which relates to the current draw, R=general gas constant: 8.3145 [J/(mol*K)], T=fuel cell temperature [K], and V=volume of the anode [m³] in a volume flow direction between two pressure measuring areas,
n_{H2_current draw}=I*t*n_{cells}/F/2 formula 2
wherein I=the current drawn from the fuel cell system [amps], t=time [s] (active time of the current drawn), n_{cells}=number of the cells in the fuel cell system which are connected in series, F=96485.3 [C/mol], and number 2 corresponds to number of electrons per H₂ molecule.

13. The method according to claim 11, wherein obtaining the reference values comprises:
measuring a reference pressure at the reference anode inlet;
measuring a reference pressure at the reference anode outlet;
wherein, during the measurement of the reference pressures, a gas flow in the reference fuel cell system is changed from 100 percentage of volume nitrogen by adding hydrogen to 100 percentage of volume hydrogen and the respective percentage of volume of hydrogen is ascertained, and wherein current drawn from the reference fuel cell system is measured in each case; and
determining the reference pressure difference Δp_{ref} from measured reference pressures.

14. The method according to claim 13, wherein the reference pressure Δp_{ref} difference determined from the measured reference pressures is composed as follows: Δp_{ref}=p_{ref_current draw}+p_{ref_volume flow}, and further comprising:
ascertaining p_{ref_current draw} according to following formulas 3 and 4:
p_{ref_current draw}=n_{ref_H2_current draw}*R*T_{ref}/V_{ref} formula 3
wherein n_{ref_H2_current} draw=material quantity [mol] of H₂ which relates to the current draw, R=general gas constant: 8.3145 [J/(mol*K)], T_{ref}=reference fuel cell temperature [K], and V_{ref}=volume of the reference anode [m³] in a volume flow direction between two pressure measuring areas,
n_{ref_H2_current draw}=I_{ref}*t*n_{ref_cells}/F/2 formula 4
wherein I_{ref}=the current drawn from the reference fuel cell system [amps], t=time [s] (active time of the current drawn), n_{ref_cells}=number of the cells in the reference fuel cell system which are connected in series, F=96485.3 [C/mol], and number 2 corresponds to number of electrons per H₂ molecule; and
ascertaining p_{ref_volume flow} from a respective gas mixture nitrogen/hydrogen.

15. The method according to claim 11, wherein the fuel cell system is operated in static operation or in dynamic operation.

16. The method according to claim 11, wherein anode exhaust gas is recirculated from the anode outlet to the anode inlet.

17. The method according to claim 16, wherein water is separated from the anode exhaust gas prior to measuring the pressure at the anode outlet.

18. The method according to claim 16, wherein the anode exhaust gas is recirculated actively by a motor.

19. The method according to claim 16, wherein the anode exhaust gas is recirculated passively.

20. The method according to claim 11, wherein second reference pressure differences Δp_{ref_2} which are 10% higher or lower than first reference pressure differences Δp_{ref_1} ascertained for this purpose at an interval of 100 ms are not considered.

21. The method according to claim 11, wherein only those reference pressures are considered for which the reference pressure difference is constant over a measurement duration of at least 100 ms.

22. A fuel cell system comprising:
at least one fuel cell having an anode, a cathode, and a membrane disposed between the anode and the cathode, the anode having an anode inlet and an anode outlet;
a first pressure sensor at the anode inlet for measuring the pressure at the anode inlet;
a second pressure sensor at the anode outlet for measuring the pressure at the anode outlet;
a temperature sensor for determining temperature [K] in the fuel cell;
a sensor for determining current [A] drawn from the fuel cell system;
a storage device containing reference values obtained for a reference fuel cell system comprising at least one reference fuel cell having a reference anode, a reference cathode, and a reference membrane disposed between the reference anode and the reference cathode, the reference anode having a reference anode inlet and a reference anode outlet; and
a monitoring device configured to determine a pressure difference (Δp) between the pressure at the anode inlet and the pressure at the anode outlet, wherein the pressure difference (Δp) is composed as follows: Δp=p_{current draw}+p_{volume flow}, compare the pressure difference (Δp) with reference pressure difference (Δp_{ref}) to ascertain volume proportions of nitrogen to hydrogen in percentage of volume, and ascertain a percentage of volume of hydrogen in the anode exhaust gas from the volume proportions of nitrogen to hydrogen; and
optionally an output device for outputting ascertained hydrogen proportion.

23. The fuel cell system according to claim 22, wherein the reference values are obtained from:
a) measurements of a reference pressure at the reference anode inlet and a reference pressure at the reference anode outlet, wherein during the measurements of the reference pressures, a gas flow in the reference fuel cell system is changed from 100 percentage of volume nitrogen by adding hydrogen to 100 percentage of volume hydrogen,
b) reference values representing the current drawn from the reference fuel cell system, and
c) reference pressure difference Δp_{ref}, wherein Δp_{ref}=p_{ref_current draw}+p_{ref_volume flow},
wherein p_{ref_current draw} is ascertained according to following formulas 3 and 4 from a measured value for the current drawn from the reference fuel cell system:
p_{ref_current draw}=n_{ref_H2_current draw}*R*T_{ref}/V_{ref} formula 3
wherein n_{ref_H2_current draw}=material quantity [mol] of H2 which relates to the current draw, R=general gas constant: 8.3145 [J/(mol*K)], T_{ref}=reference fuel cell temperature [K] and V_{ref}=volume of the reference anode [m³], and
n_{ref_H2_current draw}=I_{ref}*t*n_{ref_cells}/F/2 formula 4
wherein I_{ref}=current drawn from the reference fuel cell system [amps], t=time [s] (active time of the current drawn), n_{ref_cells}=number of the cells in the reference fuel cell system which are connected in series, F=96485.3 [C/mol], and number 2 corresponds to the number of the electrons per H₂ molecule, and
wherein p_{ref_volume flow} is determined from a respective gas mixture nitrogen/hydrogen.

24. The fuel cell system according to claim 22, further comprising:
a recirculation circuit for recirculating the anode exhaust gas from the anode outlet to the anode inlet.

25. The fuel cell system according to claim 24, further comprising:
a water separator in the recirculation circuit.

26. The fuel cell system according to claim 25, wherein the water separator is arranged upstream of the second pressure sensor.

27. The fuel cell system according to claim 24, wherein the recirculation circuit further comprises a motor for active recirculation of the anode exhaust gas.
